(19) United States
(12) Patent Application Publication
(10) Pub. No.: US 2003/0018585 A1
(43) Pub. Date: Jan. 23, 2003

(54) Method and system for the communication of assured reputation information

(75) Inventors: Nicholas David Butler, Romsey (GB); Christopher Raymond Gibson, Southampton (GB); Christopher Edward Sharp, Winchester (GB)

Correspondence Address: Jeanine S. Ray-Yarletts, IBM Corp, IP Law Dept T81/503, 3039 Cornwallis Road, PO Box 12195, Research Triangle Park, NC, 27709-2195, US

(73) Assignee: International Business Machines Corporation, Armonk, NY

(21) Appl. No.: 10/106,461

(22) Filed: Mar. 26, 2002

(30) Foreign Application Priority Data
Jul. 21, 2001 (GB) 0117811.0

(51) Int. Cl. G06F 17/60

(52) U.S. Cl. 705/53

(57) ABSTRACT

There is provided a method and system of processing electronic transactions involving three parties, normally remote from one another. A service requestor(SR) requests a good or service from a service provider(SP) on the condition that certain terms will be fulfilled indicating that the good or service is provided at a particular standard. The service provider registers with a reputation authority terms for the supply of a good or service. Independently the service requestor acquires from the reputation authority a public key for which the private key is kept by the reputation authority. The service requestor(30) requests the service provider(20) for a good or service according to certain terms and the request is sent to the reputation authority which compares registered terms with the requested terms and if compatible signs the transaction with the retained private key and sends the signed transaction back to the service requestor. The service requestor can be confident that the service provider terms in the signed transaction has been assured by the reputation authority.

### FIELD OF INVENTION

This invention relates to a method and system for the communication of assured reputation information within an electronic marketplace such as the Internet. In particular it describes a protocol for accessing reputation information held by a trusted reputation authority.

### BACKGROUND OF THE INVENTION

When entering into commercial relationships, a key factor used in the selection of service providers (SPs) is the determination of their reputation within the marketplace, i.e. assertion of their ability to deliver goods and/or services in accordance with an agreed contract. Such reputation information is typically obtained through first hand experience (a proven track record to deliver) or through extensive research into the SP's financial status and reliability (investigation and references). A service requester's (SR) ability to select new SPs based only on arbitrary and variable parameters, for example price, availability, or quality is limited without these tried and trusted techniques. The problem of reliable reputation information is exacerbated when taken in the context of global e-marketplaces where choice is increased exponentially and personal experience of each SP can be minimal if not non-existent.

Existing reputation systems are primarily concerned with the collection and analysis of reputation information. Access to the result remains a user initiated manual activity that does not scale well to large volumes of small, automated, transactions.

Such a reputation system is the Supplier Reputation Management System (SRMS) from Reputation Technologies, Inc. This system provides a relational database for the collection and storage of supplier reputation data and analytical engine for the evaluation and rating of suppliers. It is managed through user input and analysis and evaluation is queried and displayed through user interfaces. It is used as a tool for decision making outside of the electronic transaction delivery mechanism, and is inherently a manual process. However, the reputation data generated by the SRMS system would typically represent the kind of data communicated by our methods and system.

The VeriBiz Inc. company describes another kind of reputation system. They operate a service for the registration and manual evaluation of businesses. Once a business has applied for membership and passed the VeriBiz verification process, they are allowed to display an icon on their Web site providing a hyperlink to a record on the VeriBiz server certifying the said business as a verified member. This process is also manual and external to the transaction delivery mechanism. Moreover, this system offers a static evaluation that does not pertain to any specific transaction.

A comparative rating system is known from Clicksure.com, however, this reputation rating is only passed onto the original company as part of feedback. It is not passed on to customers for them to judge.

There is a requirement for a transactional delivery mechanism that allows assured access to reputation information transparently, at high volumes, and in a manner that enables informed decisions to be made programmatically.

### DISCLOSURE OF THE INVENTION

According to a first aspect of the invention there is provided a method of processing electronic assurances involving a requestor, a provider and an authority, the method comprising: the provider registering with the authority, a standard for supplying a particular good or service; the requestor acquiring, from the authority, a public key having a corresponding private key, said private key being retained by the authority; the requestor sending, to the provider, a request for assurance of a standard of a particular good or service; comparing the registered standard and the requested standard for the particular good or service, and upon a valid comparison, sending an assurance document signed, with the private key, back to the requestor; and the requestor verifying using the public key that the assurance document was validly signed, wherein the requestor can be confident that the standard in the signed assurance document has been provided by the authority.

According to a second aspect of the invention there is provided a system of processing electronic assurances involving a requestor, a provider and an authority, the system comprising: provider means for registering with the authority, a standard for supplying a particular good or service; requestor means for acquiring, from the authority, a public key having a corresponding private key, said private key being retained by the authority; requestor means for sending, to the provider, a request for assurance of a standard of a particular good or service; means for comparing the registered standard and the requested standard for the particular good or service, and upon a valid comparison, sending an assurance document signed, with the private key, back to the requestor; and requestor means for verifying using the public key that the assurance document was validly signed, wherein the requestor can be confident that the standard in the signed assurance document has been provided by the authority.

The above aspects of the invention seek to address the problem of reputation assurance and transaction delivery mechanism and advantageously allow:

a) assurances to be made conditional upon authority defined (and often domain specific) caveats—conditions applied to the assurance, for example the maximum size of an order; the quality of the order; the delivery time, the number of units.

b) assurances to be tailored and bound to specific transactions

c) bound assurances to be signed by the parties involved in the transaction rendering them tamperproof digital receipts; and

d) reputation assurances to be issued with and without the direct involvement of the authority per transaction.

In essence our system provides a means of incorporating the reputation discovery and evaluation mechanism with the electronic transaction mechanism, by means of a public key infrastructure, to provide authenticated delivery of the information.

### BRIEF DESCRIPTION OF THE DRAWINGS

These and other aspects of the invention will now be described, by way of example only, one or more embodiments and with reference to the following figures which:

FIGS. 1A, 1B and 1C represent the schematic high level architecture of the embodiment;

FIG. 2 is a schematic representation of a base assurance certificate (BAC);

FIG. 3 is a schematic method of registering a service provider (SP) with a reputation authority (RA);

FIG. 4 is a schematic flow chart of the method of identifying an RA by a service requester (SP);

FIG. 5 is a schematic flowchart of the method of asserting the SP's reputation;

FIG. 6 is a schematic flowchart of the components of a specific assurance certificate (SAC);

FIG. 7 is a schematic of the various phases of the assurance certificate;

FIG. 8 is a schematic flowchart of the order of confirmation of the order;

FIG. 9 is the schematic of the phase change of generating a self-signed specific assurance certificate from a base assurance certificate;

FIG. 10 is a schematic flowchart of the method of self-assurance of transactions by an SP.

### DESCRIPTION OF THE PREFERRED EMBODIMENTS

Preferred Embodiment: Assured Reputation Information Exchanged Securely (ARIES)

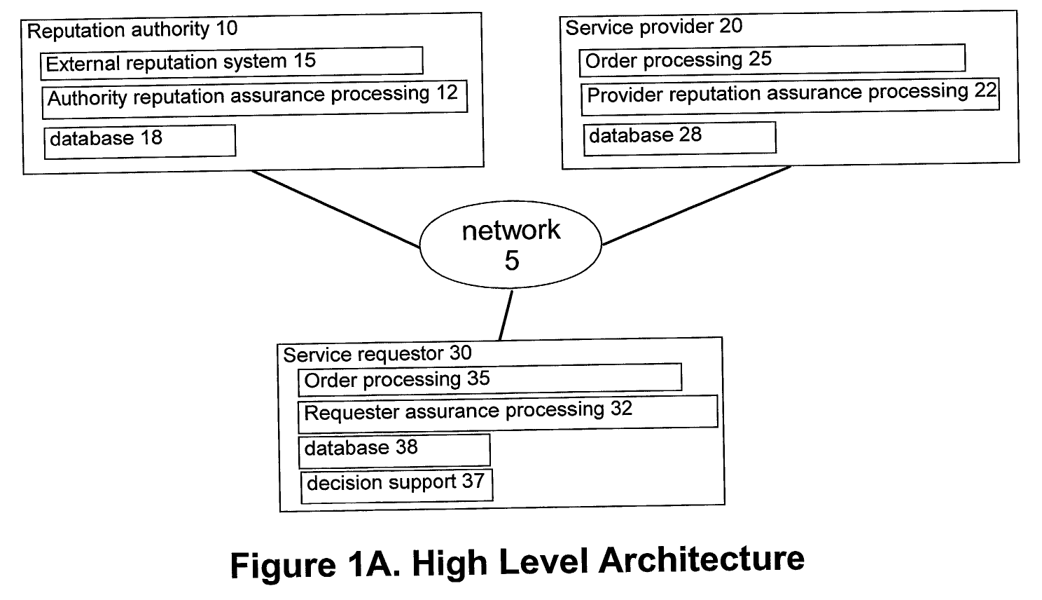

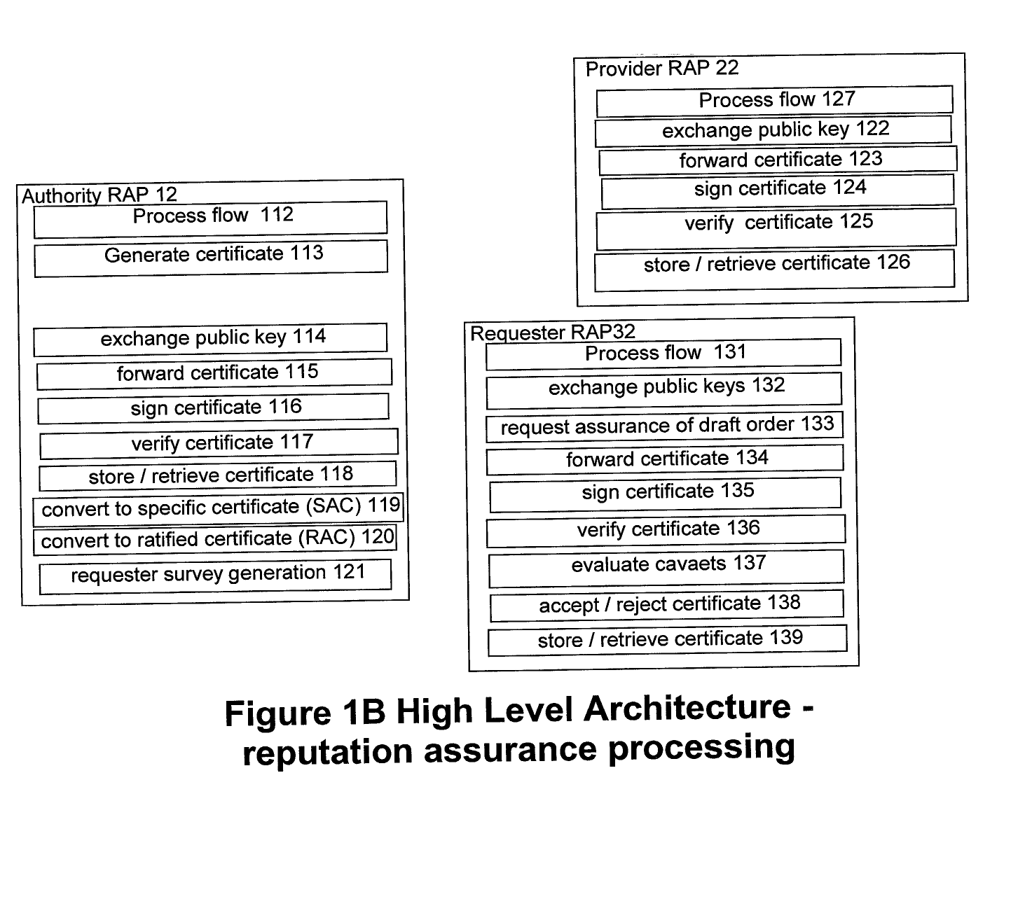

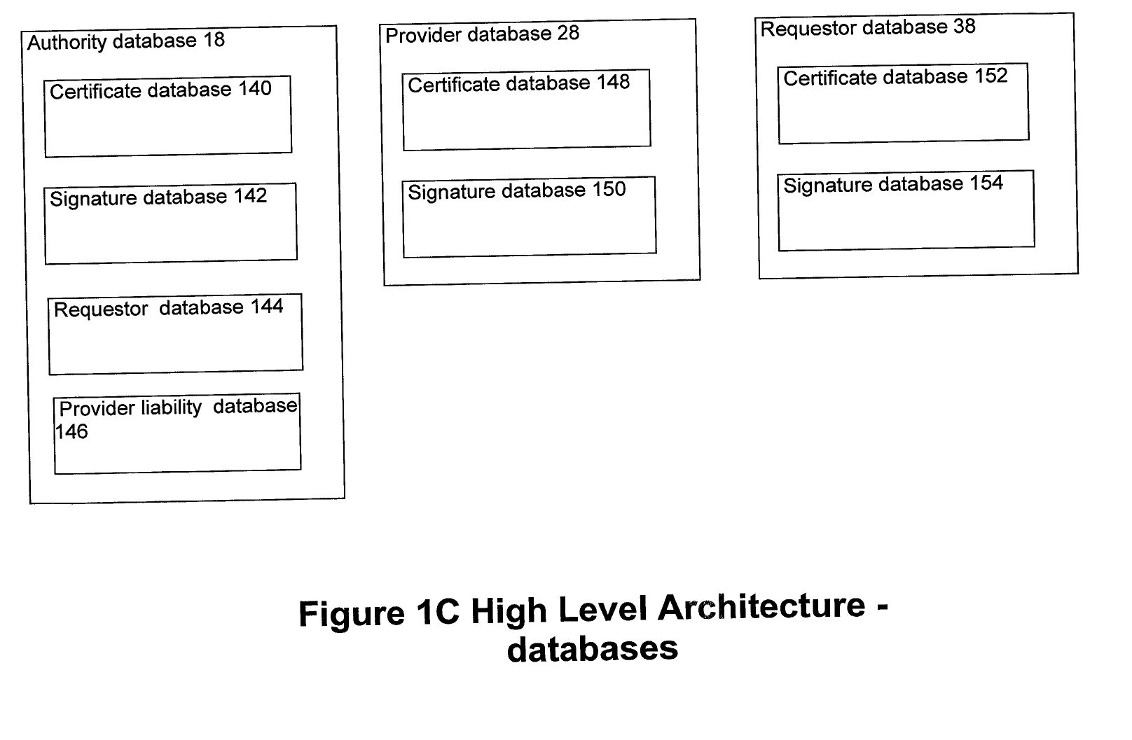

The embodiment shown in FIG. 1A provides an electronic and automatic method for the association of assured reputation information with individual transactions, and its communication between the parties involved, namely a Service Requester (30) application (SR), a Service Provider (20) application (SP) and a Reputation Authority (10) application (RA) all connected via network (5)

Each party has components specific to its role in a transaction:

Reputation Authority (10) (RA) provides: reputation assurance processing (RAP) (12); external reputation systems (15); and certificate database 18.

Service provider (20) provides: reputation assurance processing (RAP) (22); order processing (25) and certificate database (28).

Service Requester (30) provides: Reputation Assurance processing (RAP) (32), requester order processing (35); decision support SW (37); and certificate database (38).

Authority RAP (12) is the main component in the reputation authority software (see FIG. 1B). Methods within this component comprise:

Process flow (112) is the main method which controls the other methods in the authority component.

Generate certificate (113). This generates a template certificate which is used by the provider and requester to formulate details, caveats, and other data prior to generating a specific certificate.

Exchange public keys (114). This swaps public keys with a particular party, for instance swapping public keys with the provider or with the requester.

Forward certificate (115). This facilitates transporting one or other of the certificates to the other party.

Sign certificate (116). This facilitates the signing of a certificate by a private key of the authority being one half of the public/private key set.

Verify certificate (117). This takes a certificate and check that the signature corresponds to one made by a sign certificate (116, 124, 135) method.

Store/retrieve certificate (118). This acts as the certificate management and transfers all certificates (between the database (18) and the Authority RAP (12).

Generate specific assurance (119). This takes a template certificate and details of the requester's order and builds a specific assurance certificate (SAC). The SAC may also be signed by sign certificate method (116).

Convert to ratified assurance certificate (120). This takes a SAC and further signs (116) to ratify and convert to a RAC. Requester survey generation (121). This method is a post transaction request to the requester for feedback on the transaction so that the level of assurance for that provider can be monitored and adjusted if necessary.

Provider RAP (22) is the main component in the service provider software. Methods within this component include:

Process flow (127) is the main method which controls the other methods in the provider component.

Exchange public keys (122). This will swap public keys with a party, it may be initiated by the Authority RAP (12) exchange public key (114) method.

Forward certificate (123). This will facilitate transporting one or other of the certificates to the other party.

Sign certificate (124). This will facilitate the signing of a certificate by a provider private key.

Verify certificate (125). This will take a certificate and check that the signature corresponds to one made by a sign certificate (116, 124, 135) method.

Store/retrieve certificate (126). This is the provider's certificate management and transfers all certificates between the database (28) and provider RAP (22).

Requester RAP (32) is the main component in the service request or software. Methods within this component comprise:

Process flow (131) is the main method which controls the other methods in the requester component.

Exchange public key (132). As per method (122) and (114).

Request assurance of draft order (133). This method helps a requester to prepare an order before sending it to the authority for assurance.

Forward certificate (134). As per authority or provider RAP method.

Sign certificate (135). As per authority or provider RAP method.

Verify certificate (136). As per authority or provider RAP.

Evaluate caveats (137). Based on whether the caveats have been assured by the authority and whether the requester still wants to go ahead with the order a decision is made.

Accept/reject certificate (138). Once a decision has been made it is confirmed to the provider and the authority.

Authority database (18) stores certificates in certificate database (140) (see FIG. 1C). It stores its own public/private keys and public keys of the provider and requester in signature database 142. Names of requesters with addresses and feedback reports are stored in requester database 144. Provider name, assurance details and liability limits are stored in provider liability database 146.

Provider database 28 stores certificates in certificate database (148). The provider's own public/private keys and public keys of the requester and authority are stored in signature database 150.

Requester database 38 stores certificates in certificate database (152). Its own public/private keys and public keys of the provider and the authority are stored in signature database (154).

The requester order processing (35) (FIG. 1A) is for interactive (for example consumer) use supporting manual client reputation assurance processing (request/validation of reputation assurances, signing of reputation assurances to create digital receipts, and the validation of digital receipts).

The decision support method (37) is for non-interactive use supporting automatic client reputation assurance processing (request/validation of reputation assurances, exit points for programmatic buy/don't buy decision making software, signing of reputation assurances to create digital receipts, and the validation of digital receipts).

Instrumental to the operation of the embodiment is defining the method by which reputation assurances are obtained and validated. This method is described below.

1.1 Registration of Service Providers with the Reputation Authority

Reputation systems require the presence of a trusted authority in order to be effective. Typically this is an independent organisation, industry regulation body, or marketplace, which collects, analyses, and publishes reputation information about registered SPs.

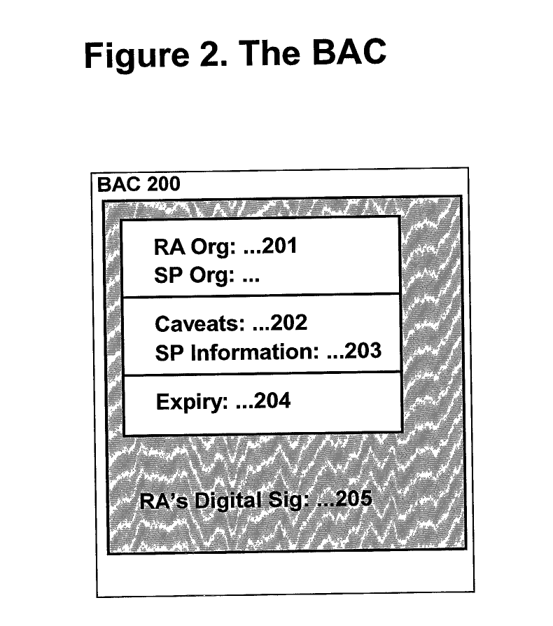

The registration process creates the relationship between the authority (10) and the SP (20). It may take many forms, for example financial and/or business references, but will result in an initial reputation assessment. Our method is not concerned with the details of this as it is already covered by existing systems used to build a RA. Upon successful registration the SP is issued with a digital certificate, called the Base Assurance Certificate (BAC) (200) (see FIG. 2), containing:

identification information (201) for both the authority RAP (12) and the provider RAP (22));

a base set of caveats (202) defining a class of services delivered by the provider that the authority is prepared to assure without further involvement (may be “none”);

other public information (203) regarding the provider that may influence the decision to proceed with a transaction (for example a customer satisfaction rating);

an expiry date (204); and

a digital signature (205) for the entire certificate, generated by the authority RAP (12).

The provider RAP (22) will record the BAC (200) in a local certificate store using ARIES. An SP may be registered with many authorities and as such multiple BACs (200) may be recorded.

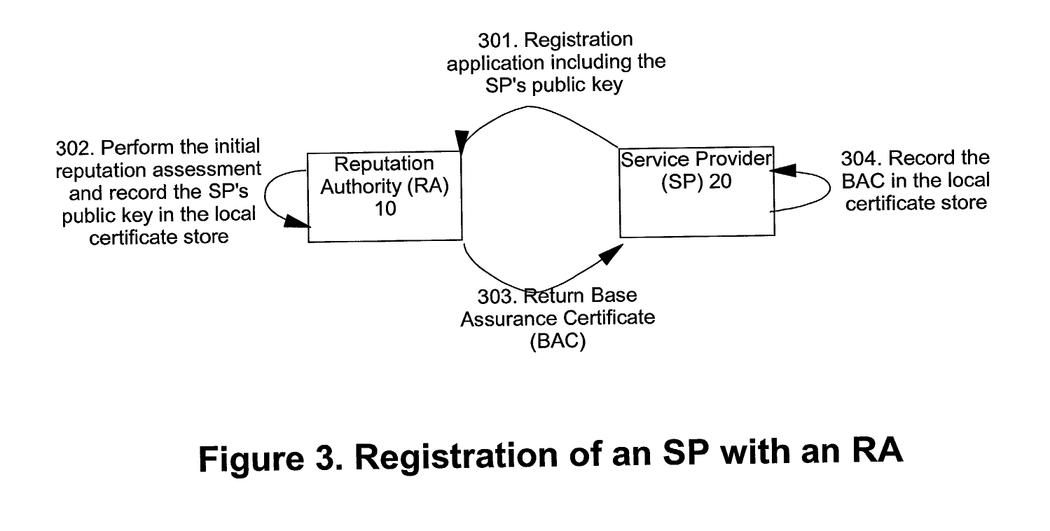

FIG. 3 shows the steps involved in the registration of the provider with the authority, and subsequent generation of a BAC (200). The SP (20) requests (301) registration and sends a copy of its public key. The RA (10) performs the initial reputation assessment and records the SP's public key in the local certificate store. The RA (10) creates a Base Assurance Certificate (BAC) and returns (303) it to the SP (20). The SP (20) stores (304) the BAC in its certificate store.

1.1.1 Base Assurance Certificates

The authority RAP (12) will generate the BAC (200). It will be based upon the notion of an attribute certificate (AC) as an extension of the X.509 standard proposed by the Internet Engineering Task Force (IETF). The suggested format for an X.509 AC is ASN.1 notation, but this has not yet been agreed, and it could be an XML representation. The X.509 Public Key Infrastructure (PKI) is a set of security standards defined and maintained by the IETF that relates to a security infrastructure based on the notions of public and private keys, certificates, and trusted certificate authority (CA) authentication. The X.509 PKI is broken into many working groups and standards, one of which is the profile for use of certificates within the context of the Internet, as defined by RFC 2459 (http://www.ietf.org/rfc/rfc2459.txt). The following is quoted from this RFC and gives a brief overview of certificates:

“Users of a public key shall be confident that the associated private key is owned by the correct remote subject (person or system) with which an encryption or digital signature mechanism will be used. This confidence is obtained through the use of public key certificates, which are data structures that bind public key values to subjects. The binding is asserted by having a trusted CA digitally sign each certificate. The CA may base this assertion upon technical means (a.k.a., proof of possession through a challenge-response protocol), presentation of the private key, or on an assertion by the subject. A certificate has a limited valid lifetime which is indicated in its signed contents. Because a certificate's signature and timeliness can be independently checked by a certificate-using client, certificates can be distributed via untrusted communications and server systems, and can be cached in unsecured storage in certificate-using systems. ITU-T X.509 (formerly CCITT X.509) or ISO/IEC/ITU 9594-8, which was first published in 1988 as part of the X.500 Directory recommendations, defines a standard certificate format [X.509].”

An AC is similar in nature to an X.509 digital certificate in that it contains information identifying the owner of the certificate (to whom the information pertains) and a digital signature of the issuing body (the certificate authority). The purpose of this is to prove the authenticity of the certificate by a trusted third party. However, an AC also contains arbitrary attributes relating to the owner of the certificate. The intended use of these is to convey information that can be used by a receiver of the certificate to determine authorization permissions. For example a server might issue an AC to a client to communicate access rights. The client would then present the AC to obtain those rights.

The use of ACs within the context of the embodiment is somewhat different. Within our model the provider presents the AC to the requester, allowing the requester to make an informed decision based on the values of the attributes it contains. Furthermore, the attributes in this embodiment contain values associated with the caveats described above rather than access related information.

1.2 Identification of Reputation Authorities to Service Requesters.

Requesters are the consumers of the information provided by a reputation system, using it to make an informed decision about a potential provider. They are themselves responsible for identifying appropriate authorities that:

a) provide information for a domain in which they are interested; and

b) they are prepared to trust.

Providers will advertise their associations with existing authorities. The authorities are themselves responsible for establishing their reputations with requesters. Our method is not concerned with the details of this, which will vary from domain to domain. However, upon selection of an authority by a requester, the requester must be able to obtain the public key supplied by said authority to validate its digital signatures. This is represented as a digital certificate known as the Authority Validation Certificate (ACV), and is the X.509 certificate published by the authority to allow validation of digital signatures.

The requester RAP (32) records the key in its local certificate store (38) ready for use. Certificates issued by multiple authorities may be recorded.

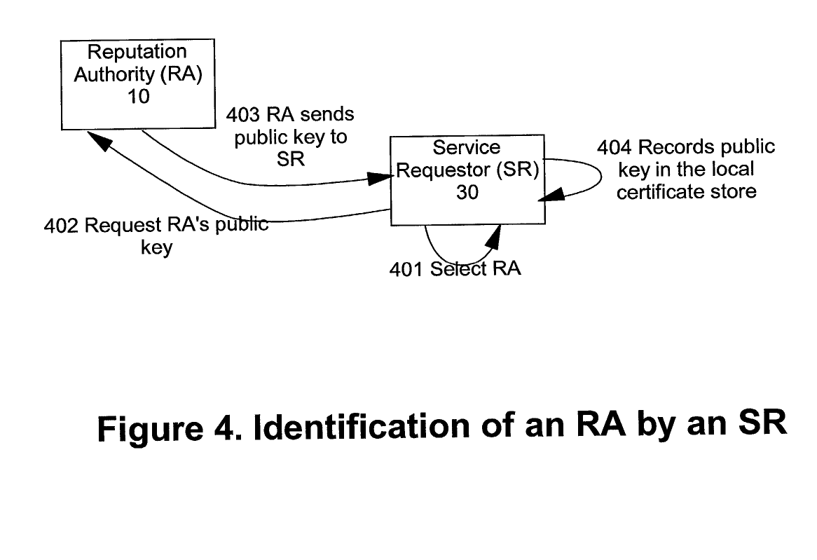

FIG. 4 shows the steps involved in the registration of the requester by the authority. The SR (30) first selects (401) an authority from a directory of authorities based on some criteria set by the requester. A request is sent (402) to the RA from the SR for the RA's public key. The RA (10) responds by sending (403) its public key back to the SR. The SR (30) then records (404) the RA's public key in its local certificate store.

1.3 Asserting the Reputation of a Service Provider

Once a requester has established the need to purchase goods or services in an electronic marketplace it will typically use some form of service directory (for example UDDI) to locate one or more suitable service providers. A requester wishing to capitalize on assured reputation information would include this requirement in the directory query. The list of candidate providers returned could be limited to those registered with authorities trusted by the requester.

The requester then uses standard on-line business protocols to browse the catalogues of these suppliers, and select the most appropriate match for their requirements based upon information published by the supplier (assessed using criteria determined by the requester). Before proceeding further the requester will download and record the RA's AVC in order that it can validate the digital signature provided/generated by the provider.

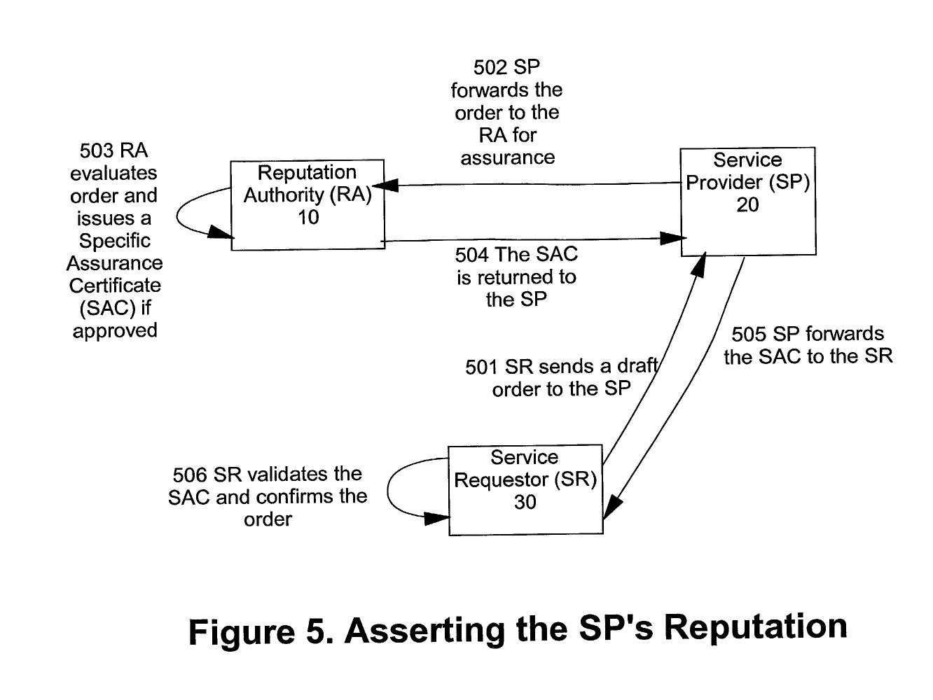

At this point the requester RAP (32) prepares a draft order (601) (see FIG. 1) which it digitally signs to prevent tampering and sends (501) to the provider RAP (22) for assurance (see FIG. 5 ). Upon receipt, the SP will send a request (502) to the authority also digitally signed to prevent tampering, asking that it assure the reputation of said provider in relation to this specific draft order.

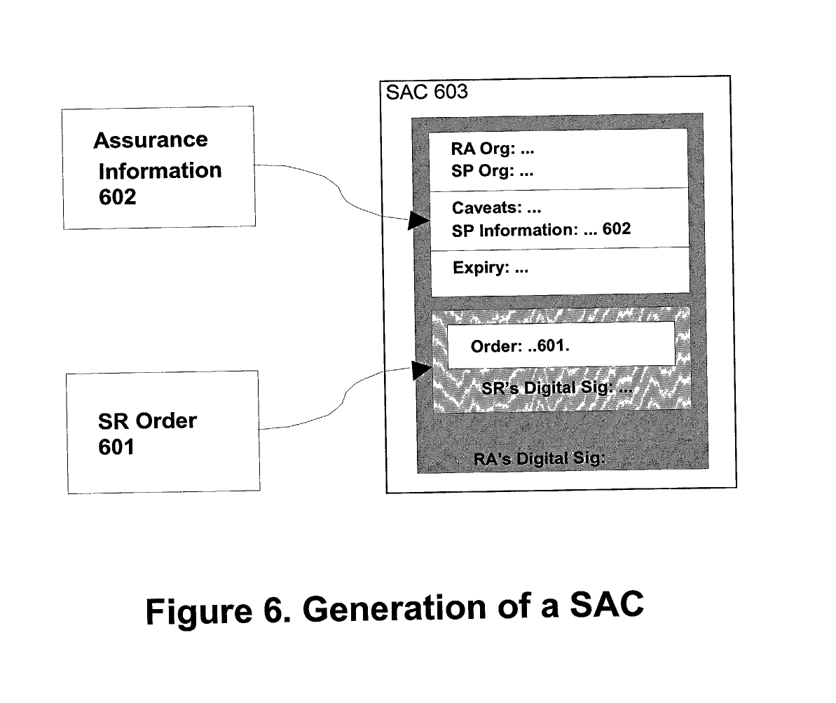

The authority first asserts that the request is valid by checking the digital signature of the provider (to ensure that a rogue trader is not masquerading as a registered SP.) Next, based upon the details of the order and the reputation status of the provider the authority will either accept or reject (503) the request. Acceptance will result in the generation of an assurance (602) that is bound to a specific requester, provider, and order (with caveats) (see FIG. 6). This is then combined (503) with the original order and the composite document is digitally signed using the authorities private key to produce a Specific Assurance Certificate (SAC) (603) (see FIG. 6) that is returned to the provider (504).

The provider RAP (22) forwards (505) the SAC onto the requester RAP (32), where the Requester RAP (32) (30) validates (506) each of the digital signatures including the RA's, thus asserting its validity. It will then evaluate the caveats and other provider information (if any) based upon configuration settings made by the user, and either accept or reject the assurance.

If the authority rejects the request for a SAC a “rejected” status is returned to provider in its place, which will be forwarded onto the requester. Should a fraudulent provider attempt to falsify a SAC the requester will detect this when requester validates the digital signature of the authority.

1.4 Order Confirmation

Once the requester has received a valid SAC containing acceptable caveats then it must confirm the order with the provider. A receipt from the provider may be sufficient to complete the transaction but this would be open to tampering. The embodiment provides a method for the generation of a tamperproof digital receipt encompassing the original SAC (603) and known as a Ratified Assurance Certificate (RAC) (704). Such a receipt may be used at a later date to prove that assurances were generated and received regarding this transaction should a complaint arise.

Furthermore, the generation of an order confirmation allows the authority to record the transaction information for each provider. This has a number of advantages:

a) in the case of a customer satisfaction reputation system, it may record the contact details of the requester so that customer satisfaction survey may be issued at a later date; and

b) in the case of a guaranteeing authority (i.e. one that issues financial guarantees along with reputation assurances), it may update its total liability with respect to the provider and feed this information back into future assurance requests.

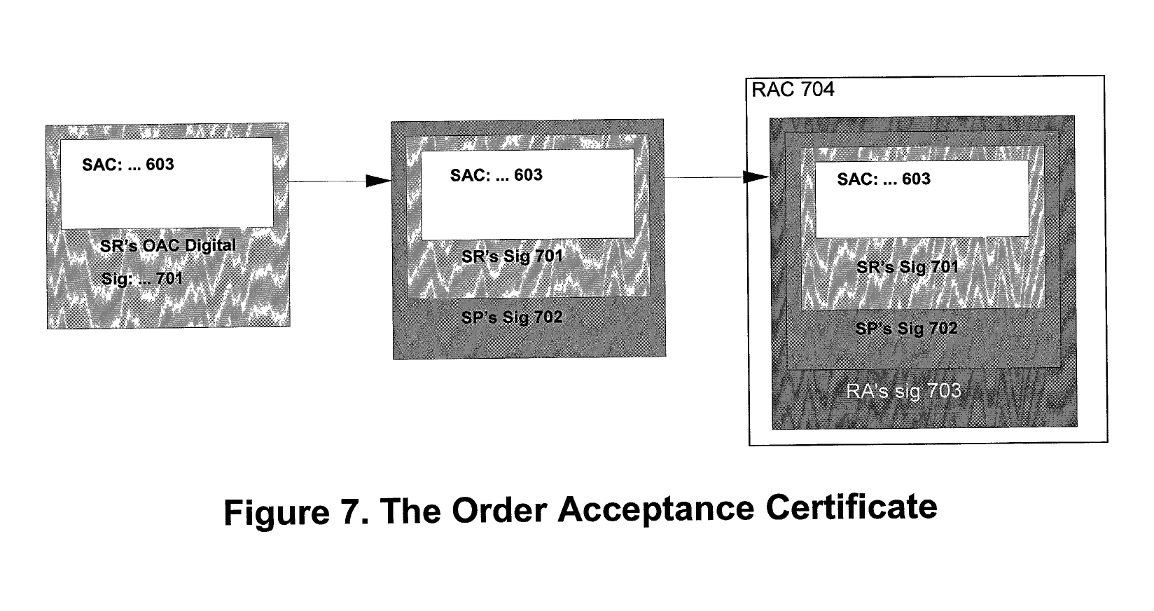

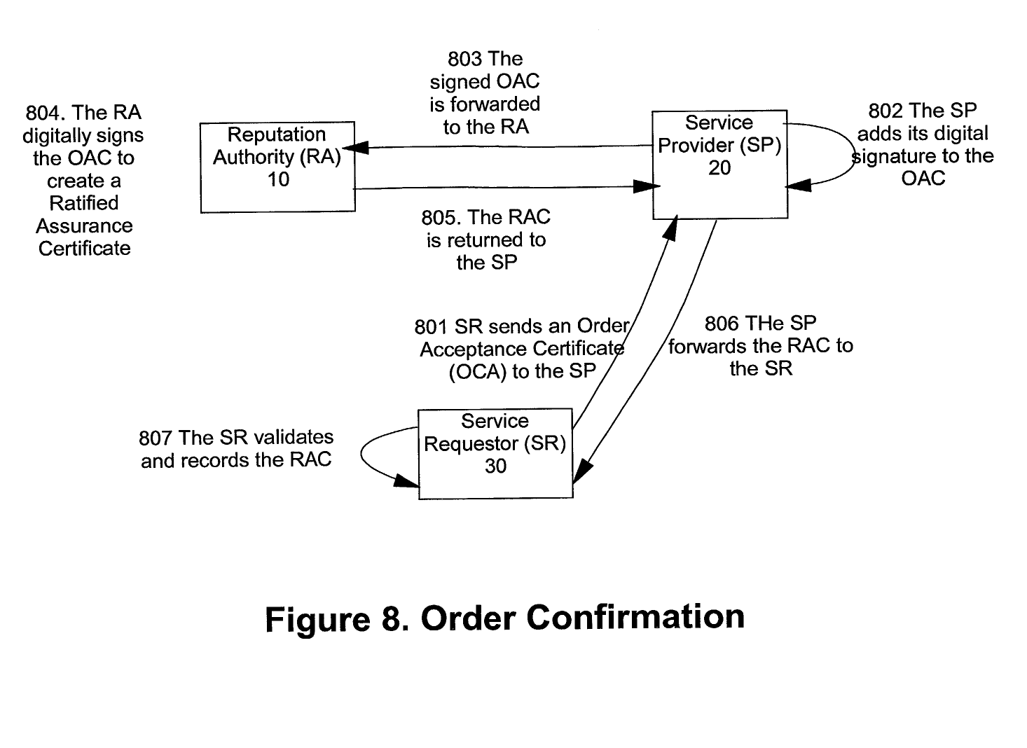

Requester RAP (32) (30) sends (801) an Order Acceptance Certificate (OAC) to the provider RAP (22) (see FIG. 7 and FIG. 8). This consists of the original SAC (603) plus a digital signature in the order acceptance field.

Upon receipt by provider RAP (22) it is further digitally signed (802) (with digital signature 702) to indicate the provider's acceptance of the order and forwarded (803) to the authority RAP (12) where it is validated and the final digital signature (703) is applied (804), rendering the triple signed SAC (603) into an RAC (704). This is then returned via (805) the provider and via (806) to the requester RAP (32) for validation (807) and filing.

4.5 Asserting Reputation without Direct Involvement from the Reputation Authority—Second Embodiment.

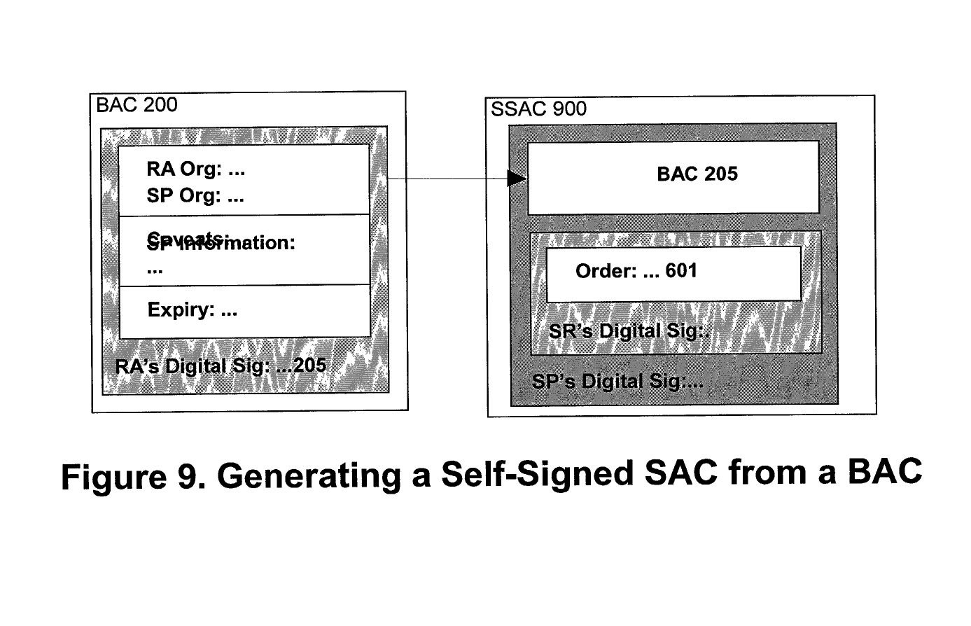

In section 4.1 it was discussed that the provider registration process resulted in the generation of a BAC (200). In a second embodiment our method allows this certificate (200) to be used by the provider to generate self-assured specific assurance certificates (SSAC) (900) (see FIG. 9).

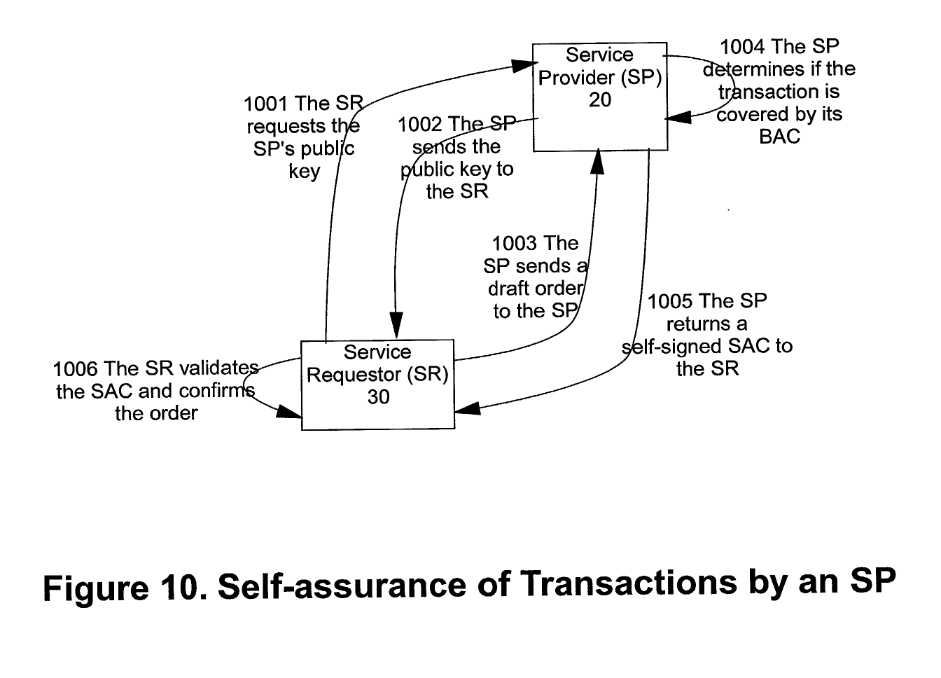

The method works as follows and as illustrated in FIG. 10. The requester RAP (32) locates a suitable provider RAP (22) as described in Section 4.3. The requester requests (1001) and obtains (1002) a public key from the provider. This key is recorded locally (this is only required once for each provider RAP (22)) in addition to the public key that it holds for the authority. The requester RAP (22) then sends its draft order (1003) to the provider RAP (22) as usual, however the provider RAP (22) does not forward it to the authority RAP (12) for approval. Instead the provider RAP (22) compares (1004) the order against the caveats contained in the BAC (200) issued by the authority, and if it falls within its parameters the provider generates (1005) its SSAC (900) containing:

a) the BAC (205);

b) the order (601) signed by the requester; and

c) a digital signature generated by the provider. The SSAC (900) is returned to the requester, where the SR validates (1006) two things:

i) that all the signatures are valid, including the RA's signature on the BAC; and

ii) that the order is covered by the terms of said BAC.

The requester then evaluates the caveats and other provider information (if any) based upon configuration settings made by the user, and either accepts or declines the assurance.

Should a fraudulent provider attempt to falsify a SAC the requester will immediately detect it when the requester validates the digital signatures.

2. Example of the Embodiment in Use: Internet Purchase Using Reputation Assurance

Increasing numbers of consumers choose to purchase new cars via the Internet rather than through a local dealer, due to the significant cost savings available. However this method carries numerous risks for example: the legitimacy of the dealers may be unknown to the consumer, or cars originating in another country may not meet local specifications, or warranty restrictions may apply. The consumer must perform extensive research into each and every possible dealer if they are to generate the confidence and trust that these and other concerns are adequately addressed, before entering into a transaction.

Using the present embodiment, it is only necessary for the consumer to establish a trust relationship with a single reputation authority offering an assurance service for Internet car dealerships (the service providers). This authority could then provide specific assurances for the consumer's individual requirements, for any dealer registered with the authority, based upon an ongoing assessment and rating process. In some cases the authority may be a non-profit consumer protection body, in others it may be a for-profit industry organisation that offers compensation to consumers who are let down by a registered dealer.

The example would work as follows:

a) An authority wishing to offer an assurance service for Internet car buying first register a number of dealers. Our system is not concerned with the details of this, however the registration process results in the generation of an initial assessment of each dealer's quality of service (for example their reliability in order fulfilment). Such an assessment include the terms under which an assurance can be generated. For example, an authority might be prepared to assure orders placed with a certain registered dealer, but only if the order value is under $20000. Other terms will be applied based upon various criteria important to either the authority and/or the consumer.

Once successfully registered the Certificate management) generates a new BAC for the dealer, record it, and send a copy to the dealer. Reputation Assurance processing (22) will automatically record the BAC in the local certificate store (28). The authority will also record the dealer's AVC (used to sign messages from the dealer) to allow it to validate the dealer's digital signatures in store (18). The dealer is now free to advertise its association with the authority along with its products as an incentive to potential customers.

b) A consumer wishing to purchase a car first establishes a trust relationship with one or more suitable authorities. Once again our system is not concerned with the details of this, and indeed it will vary from domain to domain. Having chosen an authority the consumer connects to its Web site using a Web browser configured to run the service requestor (30) (i.e. service requestor (30) has been installed). One of the authority Web pages would include a button or link labelled “Trust this reputation authority” or similar. The consumer would click it, invoking code that downloads the authority key to the reputation assurance processing (32), which will record it in the local certificate store (38). The consumer then performs a search for a suitable car to purchase, confining potential dealers to those registered with the trusted authority (or authorities). A number of methods may be employed to do this. For example the consumer may perform a Web search, or consult an online directory of dealers, or consult an online catalogue. The resulting product Web pages for each suitable dealer would contain an “Obtain transaction assurance” button or link to the authority's assurance information for that specific dealer and product. The consumer uses this to obtain an assurance certificate that has been digitally signed by the authority.

What happens next depends upon whether the dealer is obtaining per-transaction assurances from the authority or generating them locally using its BAC.

2.1 Authority Generated Assurance Certificates

If the authority requires the dealer to obtain assurance certificates per-transaction, clicking on “Obtain transaction assurance” will:

a) invoke the dealer's reputation assurance processing (22) to send a request to the RA's reputation assurance processing to provide a reputation assurance for the dealer and the selected product;

b) a SAC is generated by the RA's certificate management and returned to the dealer including any terms (caveats) added by the reputation assurance processing (12) (for example the authority may indicate that the assurance is only valid for transactions valued up to $20000).

The dealer generates a Web page response for the consumer that invokes the reputation assurance processing (32) in the consumer's browser to:

c) receive the SAC generated by the authority;

d) validate the expiry date, dealer organisation and signature, and the authority's signature contained within it; and

e) display the information to the consumer (including the terms it contains and/or validation failures).

Based upon this information and the product details the consumer makes a decision whether or not to buy. The terms of the assurance are important at this stage. For example suppose that the consumer is buying a car valued at $23000, but the authority added terms to the assurance indicating that the dealer is only assured for purchases up to $20000. The consumer may decide not to purchase from this dealer. If the authority terms indicated that purchases up to $25000 are assured then the consumer can be confident that the purchase is safe.

2.2 Dealer Generated Assurances Using the BAC

If the terms of the consumer's transaction fall within the bounds indicated in the BAC then the dealer may opt to generate the assurance locally rather than contact the authority. It is important to note that it is the authority's decision as to what may, or may not, be assured in this way—in some cases the authority may choose to disallow the dealer from providing this service.

If the dealer is going to provide the assurance certificate for this transaction, the consumer action of clicking on the “Obtain transaction assurance” link will cause certificate management system to generate a SAC containing the BAC supplied by the authority. Use of the BAC will automatically include any terms added by the authority (for example the authority may indicate that the BAC assurance is only valid for transactions valued up to $15000).

The dealer generates a Web page response for the consumer that invokes the requester RAP to:

a) receive the SAC generated by the SP and containing the BAC;

b) validate the expiry date, dealer organisation and signature, and the authority signature contained within the BAC; and

c) display the information to the consumer (including the terms it contains and/or validation failures).

Based upon this information and the product details the consumer makes a decision whether or not to buy, the terms of the assurance being checked as described in Section 5.1 above.

2.3 Order Confirmation

In both of the above scenarios confirmation of the transaction by the consumer invokes the reputation assurance processing (32) to generate a digital receipt:

a) the consumer selects a “Confirm Transaction” button or link on the dealer's Web site;

b) the consumer's reputation assurance processing (32) sign the SAC, converting it into an OAC, which it sends to the provider;

c) the reputation assurance processing (12) on the dealer's system signs the OAC and sends it on to the authority;

d) Reputation assurance processing (12) on the authority checks the dealer's signature and then signs the OAC converting it into an RAC, records it locally in the certificate store (18), and returns it to SP (20) (at this stage the authority knows that it should seek to update the dealer's reputation information based upon feedback from the buyer); and

e) Provider RAP (20) records the RAC locally in the certificate store, and returns it to the SR (30) where it is validated and recorded in the local certificate store (38).

f) The final step will be for the consumer feedback process to be invoked by the authority. The consumer will be surveyed for their opinion of the seller in the form of an e-mail survey, a Web page form, or some other process, and the resulting data will be fed into the authority's back-end reputation system to update the dealer's reputation for subsequent transactions.

3. Further Embodiment in Use: Online Peer to Peer Auction Services Using Reputation Assurance.

Online auction systems such as eBay provide a closed system where all users, buyers and sellers, are required to register. Sellers are able to add items to the system for auction categorizing them and providing a starting price and descriptive details. Potential buyers are able to search for items by keyword or browse through the categories, giving a “window shopping” experience.

When a potential buyer find an item they wish to purchase they submit a bid. The auction is time-based, and users are able to see the current leading bid. Potential buyers may submit new bids at any time up until the auction closes. The winning bid is the highest at the time this happens. Once the auction has closed the system announces to the seller and the winning bidder each others details and encourages them to contact each other as soon as possible. The auction system now presents both the buyer and seller with a mechanism for providing feedback that rates how well the other party behaved with respect to this transaction. Feedback is classified as positive, negative, or neutral, and comments are submitted in free text form.

The system maintains a value which is the number of positive feedback reports minus the number of negative feedback reports associated with each user of the system, and this value is listed next to the user's ID when it appears as a buyer or seller. Such an indicator is a primitive rendering of reputation and is provided to assist in determining whether or not to enter into financial transactions with that user. Negative values indicate that a user has behaved badly in previous transactions.

An authority (10) provides reputation information for a number of providers to accumulate one set of reputation data which is available for use in a variety of auction houses:

3.1 A first time (i.e. unregistered) seller connects to the authority Web site using their Web browser. The browser must already have been configured to run the service provider (20) software (i.e. service provider (20) has been installed has been installed).

3.2 One of the options on the authority (10) Web site is “New Seller Registration”. A potential seller selects this link to invoke the registration process, and a page is loaded that requests basic identification information. Having entered this the seller clicks the “OK” button on the page and the information is passed to the authority's RAP (12). If the registration request is approved the certificate management.

In this example sellers are likely to be registered without question. This is safe because the initial BAC issued would indicate that they had not yet established a good (or bad) track record with the authority (10).

3.3. A provider would then advertise a product via the auction system hosted by the authority, and the catalogue entry provided would publish a link to the seller's reputation information on the authority.

Using a Web browser, a buyer (requestor) connects to the auction system Web site and uses a search facility to locate suitable products in the online catalogue. As the Web page for each matching product is viewed, the buyer may follow the link to the seller's reputation information which will:

a) invoke the authority (10) to provide a reputation assurance for the seller, for this product;

b) the authority (10) will invoke reputation assurance processing (12) passing it the details of the seller and the product to obtain reputation information; and

c) a SAC is generated by the reputation assurance processing (12) and certificate management (18)

Reputation assurance processing (32) in the requester's browser:

d) Receives the SAC from the authority;

e) Validates the expiry date and the signature contained within it; and

f) Displays the information to the user (including caveats and/or validation failures).

Based upon this information and the product details the buyer will make a decision whether or not to bid.

3.4. The bid process operates using the same mechanisms currently employed by e-commerce auction systems. When the auction closes, the buyer (the successful bidder) and the seller will be notified and the transaction proceeds to completion. Confirmation of the transaction by the buyer invokes the process to generate a digital receipt:

a) the buyer selects a “Confirm Transaction” button on the auction system Web site;

b) the buyer's reputation assurance processing 32) is invoked to sign the SAC, converting it into an OAC, and send it to the seller.

c) the seller's reputation assurance processing (22) signs the OAC and sends it to the authority.

d) reputation assurance processing (12) on the authority (10) signs the OAC converting it into an RAC, records it locally in the certificate store (18), (at this stage the authority (10) knows that it should seek to update the seller's reputation information based upon feedback from the buyer); and returns it via the seller to the buyer.

3.5. The final step is for the buyer feedback process to be invoked by the authority. The buyer is surveyed for their opinion of the seller in the form of an e-mail questionnaire, a Web page form, or some other process, and the resulting data will be fed into the RA's back-end reputation system to update the seller's reputation for subsequent transactions.

In the embodiment the requestor signs the verified transaction certificate, followed by the provider and then the authority so that a certificate signed by all three parties confirms the order and acts as an unique tamperproof document which may be used as a guarantee. However, it is not necessary that all the parties sign the verified transaction certificate, one or two parties may sign the certificate depending on the particular e-commerce system. Also it is not important which order the certificate is signed, the requestor may sign first or last and similarly with the provider and authority.

What is claimed is:

1. A method of processing electronic assurances involving a requestor, a provider and an authority, the method comprising:
the provider registering with the authority, a standard for supplying a particular good or service;
the requestor acquiring, from the authority, a public key having a corresponding private key, said private key being retained by the authority;
the requestor sending, to the provider, a request for assurance of a standard of a particular good or service;
comparing the registered standard and the requested standard for the particular good or service, and upon a valid comparison, sending an assurance document signed, with the private key, back to the requestor; and
the requestor verifying using the public key that the assurance document was validly signed, wherein the requestor can be confident that the standard in the signed assurance document has been provided by the authority.

2. A method as in claim 1 further comprising:
the provider requesting the authority to assure the standard in relation to providing the requested good or service; and
the authority performing the comparing and signing step.

3. A method as in claim 1 further comprising:
the provider assuring the requested standard in relation to providing the good or service by performing the comparing step and sending back a pre-signed assurance document which matches the requested standard, said pre-signing being performed by the authority.

4. A method as in claim 1 further comprising the requestor appending a confirmation to the signed assurance document thereby forming a confirmed signed assurance document for completion of an order for said good or service.

5. A method as in claim 4 further comprising the authority receiving the confirmed signed assurance document and upon positive verification of its original signature ratifying the confirmed signed assurance document by further signing it to create a tamperproof digital receipt; and
the requestor verifying using the public key that the confirmed signed assurance document was ratified by the authority wherein the requestor can be confident that it is genuine receipt from the authority.

6. A method as in claim 3 further comprising the authority generating a base assurance document having ranges of standard of good or service defined at registration.

7. A method as in claim 6 further comprising the authority pre-signing the base assurance document.

8. A method as in claim 6 further comprising the provider acquiring a base assurance document from the authority after registration of the standard.

9. A method as in claim 1 further comprising the authority generating a specific assurance document by setting a specific standard from accepted ranges defined at registration.

10. A system of processing electronic assurances involving a requestor, a provider and an authority, the system comprising:
provider means for registering with the authority, a standard for supplying a particular good or service;
requestor means for acquiring, from the authority, a public key having a corresponding private key, said private key being retained by the authority;
requestor means for sending, to the provider, a request for assurance of a standard of a particular good or service;
means for comparing the registered standard and the requested standard for the particular good or service, and upon a valid comparison, sending an assurance document signed, with the private key, back to the requestor; and
requestor means for verifying using the public key that the assurance document was validly signed, wherein the requestor can be confident that the standard in the signed assurance document has been provided by the authority.

11. A system as in claim 10 further comprising:
provider means for requesting the authority to assure the standard in relation to providing the requested good or service; and
authority means for performing the comparing and signing step.

12. A system as in claim 10 further comprising:
provider means for assuring the requested standard in relation to providing the good or service by performing the comparing step and sending back a pre-signed assurance document which matches the requested standard, said pre-signing being performed by the authority.

13. A system as in claim 10 further comprising requestor means for appending a confirmation to the signed assurance document thereby forming a confirmed signed assurance document for completion of an order for said good or service.

14. A system as in claim 13 further comprising authority means for receiving the confirmed signed assurance document and upon positive verification of its original signature ratifying the confirmed signed assurance document by further signing it to create a tamperproof digital receipt; and
requestor means for verifying using the public key that the confirmed signed assurance document was ratified by the authority wherein the requestor can be confident that it is genuine receipt from the authority.

15. A system as in claim 12 further comprising authority means for generating a base assurance document having ranges of standard of good or service defined at registration.

16. A system as in claim 15 further comprising authority means for pre-signing the base assurance document.

17. A system as in claim 16 further comprising provider means for acquiring a base assurance document from the authority after registration of the standard.

18. A system as in claim 10 further comprising authority means for generating a specific assurance document by setting a specific standard from accepted ranges defined at registration.

19. A computer program product comprising computer program code stored on a computer readable medium for, when executed on a computer, processing electronic assurances involving a requestor, a provider and an authority, the product comprising:
provider means for registering with the authority, a standard for supplying a particular good or service;
requestor means for acquiring, from the authority, a public key having a corresponding private key, said private key being retained by the authority;
requestor means for sending, to the provider, a request for assurance of a standard of a particular good or service;
means for comparing the registered standard and the requested standard for the particular good or service, and upon a valid comparison, sending an assurance document signed, with the private key, back to the requestor; and
requestor means for verifying using the public key that the assurance document was validly signed, wherein the requestor can be confident that the standard in the signed assurance document has been provided by the authority.

20. A product system as in claim 10 further comprising:
provider means for requesting the authority to assure the standard in relation to providing the requested good or service; and
authority means for performing the comparing and signing step.

21. A system as in claim 19 further comprising:
provider means for assuring the requested standard in relation to providing the good or service by performing the comparing step and sending back a pre-signed assurance document which matches the requested standard, said pre-signing being performed by the authority.

22. A product as in claim 19 further comprising requestor means for appending a confirmation to the signed assurance document thereby forming a confirmed signed assurance document for completion of an order for said good or service.

23. A product as in claim 22 further comprising authority means for receiving the confirmed signed assurance document and upon positive verification of its original signature ratifying the confirmed signed assurance document by further signing it to create a tamperproof digital receipt; and
requestor means for verifying using the public key that the confirmed signed assurance document was ratified by the authority wherein
the requestor can be confident that it is genuine receipt from the authority.

24. A product as in claim 21 further comprising authority means for generating a base assurance document having ranges of standard of good or service defined at registration.

25. A product as in claim 24 further comprising authority means for pre-signing the base assurance document.

26. A product as in claim 25 further comprising provider means for acquiring a base assurance document from the authority after registration of the standard.

27. A product as in claim 19 further comprising authority means for generating a specific assurance document by setting a specific standard from accepted ranges defined at registration.
